(19) United States
(12) Patent Application Publication
(10) Pub. No.: US 2002/0007708 A1
(43) Pub. Date: Jan. 24, 2002

(54) Devices, systems and methods for aligning and cutting cards

(76) Inventor: William Howard Freeman, Tucson, AZ (US)

Correspondence Address: WILLIAM H. FREEMAN, 9811 E. 5TH ST., TUCSON, AZ, 85748, US

(21) Appl. No.: 09/908,758

(22) Filed: Jul. 19, 2001

Related U.S. Application Data
(60) Provisional application No. 60/219,709, filed on Jul. 19, 2000.

(51) Int. Cl. B26D 7/01

(52) U.S. Cl. 83/36; 83/249; 83/467.1; 83/605

(57) ABSTRACT

The invention provides an alignment device comprising a surface having a plurality of guides for positioning a card stock for cutting, and arranged in a manner that promotes a logical cutting sequence. The invention is also a method for operating a card cutting alignment system, comprising aligning paper stock using the alignment device, and cutting the aligned paper with a cutting means to produce a business card.

### RELATED APPLICATION

The invention is related to and claim priority from pending U.S. Provisional Application No. 60/219,709 entitled “Que 'N Cut”, by William H. Freeman, filed on Jul. 19, 2000. Small entity status is likewise claimed from the same application.

### TECHNICAL FIELD

Generally, the invention relates to the field of office supplies accessories, and, more particularly, the invention relates to business card cutter apparatuses.

### STATEMENT OF A PROBLEM ADDRESSED BY THE INVENTION

As home-offices have become more common, home-office supplies have become more sophisticated, and allow even the smallest of businesses to provide professional appearance that is needed to compete with the largest corporations. Perhaps the most critical business tool for today's professional is the business card. Practically all business persons use business cards during the conduct of business.

For small business owners or those on restricted budgets, the purchase of business cards represents a significant expense because professional printers require expensive minimum orders of five hundred or more card to justify set-up and operating costs to run expensive automated cutting systems. In addition, automated business card printings often restrict the business person's flexibility in targeting business cards to specific contacts. For this reason, many business persons who use home offices or who have the need for small quantities of business cards often look to printer-generated (or “stock”) business cards. However, such printer-generated business cards are not without drawback. For example, pre-perforated card stock for printer-generated cards is expensive and often has inconsistent quality. In addition, the cutting and tearing techniques are time consuming and result in cards that are not professional in appearance, and that are of an inconsistent quality. For example, pre-perforated card stock can lead to ragged, uneven edges on business cards. This can actually create a negative impression, rather than the positive image that is desired.

Furthermore, using printer-generated business cards can pose significant threats to the safety of office workers who attempt to cut their own cards. This danger is a result of the inherent instability of hand held razor knives or single edge razor blades that some people now use, and due to the large cutting surfaces of larger paper-cutters. Therefore, there is needed a device, system and method for providing business cards that is quick, safe, and produces cards having a professional appearance.

### SELECTED OVERVIEW OF SELECTED EMBODIMENTS

The invention provides technical and operational advantages as a card alignment method. One method aligns paper stock so that it is positioned to be cut, preferably by utilizing a system of a alignment devices disposed on a cutting means. Another method passes paper stock through a series of alignment guides, and may cut a business card by using device that integrates a cutting device with an alignment device. The invention also provides systems and devices. One device embodiment is a card alignment device that includes a planar surface, and ridges, steps, tabs, or other alignment means to provide alignment and proper distance for cutting business cards.

The methods according to the teachings of the invention may provide operations, such as alignment operations. In addition, the invention may provide for a variety of functions, such as multiple positioning functions. In selected embodiments, the invention may incorporate a cutting device unique to a alignment device and may provide the cutting device integrated with the alignment device. Accordingly, the invention provides inventive embodiments that save worker time, prevent worker injury, and result in a more professional appearance for business cards. Thus, employers will save money due to increased worker productivity, and fewer workers' compensation claims.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 is a flow-diagram of a card alignment and cutting operation;

FIG. 2 is one embodiment of a card alignment device; and

FIG. 3 is one embodiment of a card alignment and cutting system.

### AN EXEMPLARY EMBODIMENT OF A BEST MODE

The invention provides inventive embodiments that save worker time, prevent worker injury, and cost-effectively align paper stock for cutting into clean cut, professional looking business cards. One preferred method aligns paper stock through a series of positions and cuts, resulting in finished business cards. One preferred device is a card alignment device that includes a planar surface and a series of ridges positioned to provide alignment and proper distance for cutting business cards. This allows for business cards of appropriate size and professional appearance. Accordingly, among the invention's many advantages that are readily apparent to those of ordinary skill in the art, the invention saves its users money over professional printing, increases worker productivity when creating cards, and saves worker injury thus reducing the number of workers' compensation claims.

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step as defined in 112, paragraph 6 of 35 U.S.C., unless used as “means for functioning-” or “step” for -functioning-” in the claims section.

Exemplary Device

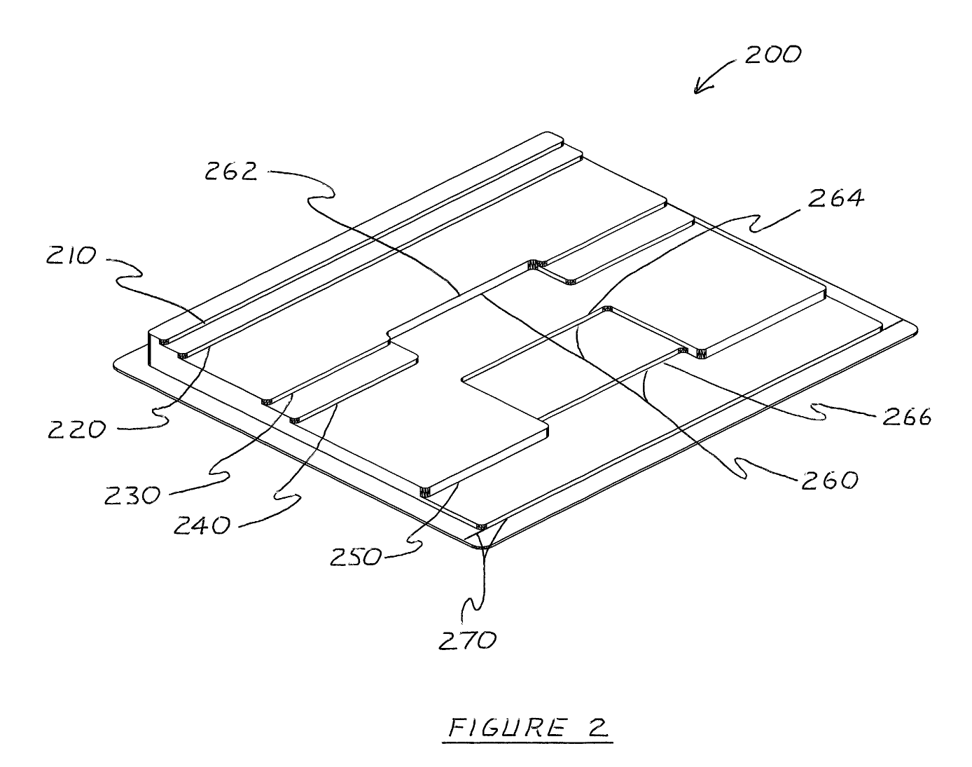

FIG. 2 is one embodiment of a card alignment device (the device) 200. The device 200 generally comprises a plurality of planar surfaces having a plurality of ridges (or guides) against which card stock paper may be positioned to allow correct cutting distances and angles so that business cards may be quickly cut from card stock. Preferably, each guide of the invention is shaped to accommodate a card stock in a position to most securely hold the card stock for a successive cut. This is particularly desirable for card-width cutting guides. For example, a first guide 210 is for positioning card paper stock so that a cutting means can cleanly cut a bottom margin from a business card paper stock, and is shaped to accommodate an entire paper-size card stock.

Subsequently, a second guide 220 is for positioning a card stock (preferably, after the bottom has been trimmed) so that a cutting means can cleanly trim a top margin from the card stock. Similarly, a third guide 230 is for positioning a first side of the card stock paper so that a first margin can be removed from the card stock. Likewise, a fourth guide 240 is for positioning the card stock so that a second margin can be removed from the card stock by the cutting means.

Typically, on a card stock, ten or twelve business cards are positioned in two rows, with five or six cards in each row. Accordingly, to cut out the business card, additional guides are desired. A fifth guide 250 is for positioning the card stock so that a cut may be made down the center of a card stock that has had its margins removed. In one preferred embodiment, with the center line cut, there are two resulting ten inch by three-and-a-half inch paper rectangles (the paper rectangles).

The paper rectangles need to be cut into business cards. Card-width cutting guides 260 are used to securely hold the paper rectangles for further cutting. Thus, a sixth guide 262 is positioned furthest from a blade maintained by the cutting means. When placed in the sixth guide 262, exactly one card is beyond the blade. Each subsequent guide 260 position is the height of a business card distance closer to the blade maintained in the cutting means. In a preferred embodiment, this distance is two inches. Accordingly, after being placed in each successive card-width cutting guide 260, the paper rectangles are converted into a predetermined number of rectangular business cards having approximately equal dimensions. Note that a guide/tab 270 may be used as a guide, used to secure the device on a cutting means, or may serve both purposes. In addition, one should note the generally step-wise arrangement of the guides 210-270. This allows for a step-wise and logical flow for creating business cards from card stock, which can be better understood by examining an exemplary method.

Exemplary Method

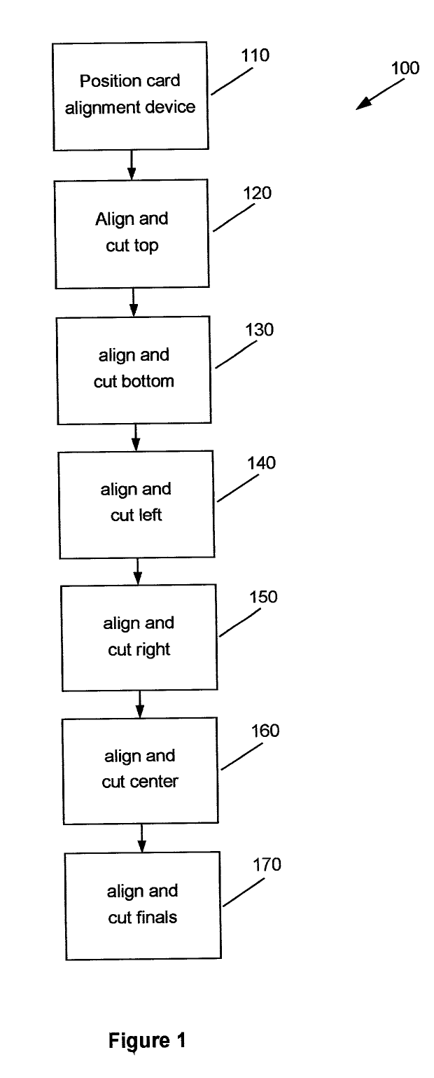

To more fully appreciate the invention, one may consider a card alignment and cutting process according to the teachings of the invention. FIG. 1 illustrates a card alignment and cutting process 100. The card alignment and cutting process (the process) 100 begins with a position card alignment device act 110 that disposes the card alignment device on or about a cutting means, such as a paper-cutter. Then, in an align and cut top act 120, the paper is positioned along a first ridge, and a blade of the cutting device is used to cut a top margin from a card stock. This securely positions the business card stock so that the top of the card stock sheet can be cut at the correct location, without requiring measurements. The other align and cut acts are similarly performed to accommodate the dimensions of paper stock.

Thus, during an align and cut bottom act 130, the card stock is positioned against a second guide, and the blade is used to cut the bottom margin of the card stock at the correct location. Similarly, an align and cut left act 140 positions the card stock against the fourth guide and uses the blade to cut the left side of the paper stock. Likewise, an align and cut right act 150 aligns the card stock and uses a blade to cut a right margin from the card stock. An align and cut center act 160 positions the card stock, and a blade cuts the respective sheet into two columns. Then, an align and cut finals act 170 positions the paper columns a predetermined number of times, and a blade cuts the paper column following each respective positioning, to produce business cards of predetermined dimensions.

Exemplary System

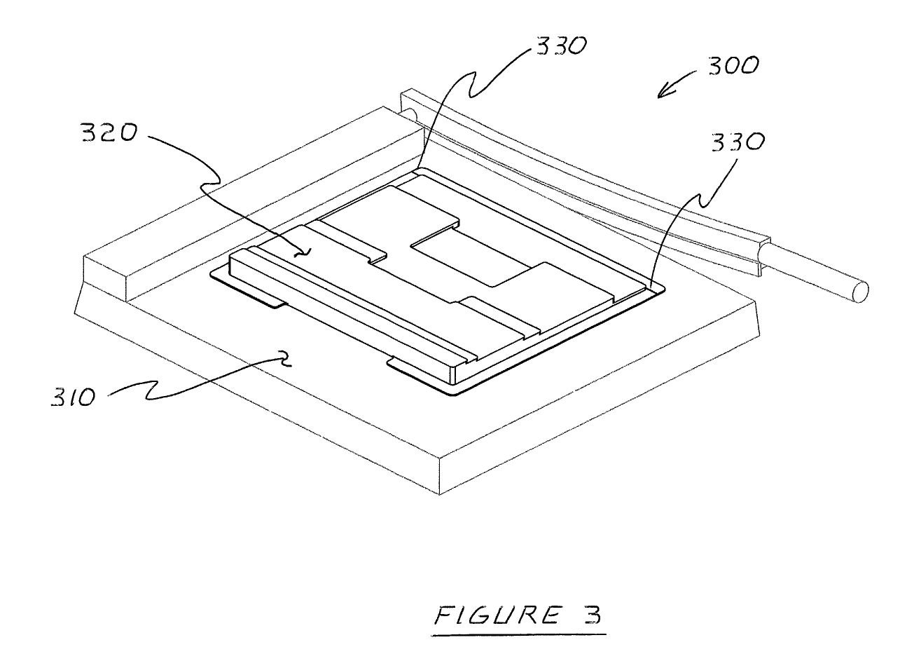

A card alignment device may be used with any cutting means to create a card alignment and cutting system. Accordingly, FIG. 3 shows a card alignment and cutting system (the system) 300. The system 300 generally comprises a card cutting means embodied as card cutter 310, and a card alignment device (the device) 320 disposed on the card cutter 310. The device 320 is preferably positioned on the card cutter 310 using a positioning means, such as tabs 330, that are fixedly or removably mounted on the card cutter 310 so that correct alignment and distance can be maintained during the cutting of card paper stock. In a preferred embodiment the card cutter can be flush-mounted or integrated with a cutting device to form a single cutting-positioning unit. In another embodiment, the card cutter can be snapped into a cutting device to form a single cutting-positioning unit.

Though the invention has been described with respect to a specific preferred embodiment, many variations and modifications will become apparent to those skilled in the art upon reading the present application. For example, although the specific embodiment of a business card cutter has been described, it should be understood that the principles taught herein can be applied to any cutter of any paper stock to achieve a logical template for use to cut any paper, such as a post-card, for example. It is therefore the intention that the appended claims be interpreted as broadly as possible in view of the prior art to include all such variations and modifications.

I claim:

1. A method of cutting a paper to achieve a predetermined paper shape and paper size, comprising:
aligning the paper using an alignment device; and
cutting the paper with a cutting means.

2. The method for claim further comprising applying an alignment device to a cutting means.

3. The method for claim 2 further comprising temporarily attaching the alignment device to the cutting means.

4. The method of claim one wherein aligning comprises placing the paper within a notch of a ridge of the alignment device.

5. A business card cutting system, comprising:
a cutting means; and
an alignment device disposed on the cutting means.

6. The system of claim 5 wherein the alignment device is coupled to the cutting means via an attaching means for securing the alignment device to the cutting means.

7. A system of claim 5 wherein the cutting means is a paper cutter.

8. A system of claim 6 wherein a plurality of tabs are positioned and secured to the cutting means, and the tabs secure the alignment device on the cutting means.

9. A system of claim 5 wherein the cutting means is integrated with the alignment device as a single unit.

10. A system of claim 9 wherein the alignment device and the cutting means are integrated into a single unit via at least one snap.

11. A system of claim 9 wherein the alignment device and the cutting means are molded into a single unit.

12. A cutting device, comprising:
a first generally planar surface; and
a second generally planar surface having a height, the second generally planar surface being disposed on and slightly offset from the first planar surface in a predetermined position so that when a paper is placed partially on the first generally paper surface and against a ridge created by the height of the second generally planar surface, a cut may be made by a cutting device at a predetermined location on the paper.

13. The cutting device of claim 12, wherein:
the second generally planar surface has a groove, the groove being generally shaped to receive a paper to be cut; and
wherein the groove is located in a position of the second generally planar surface so that the paper may be cut with a cutting means to achieve a predetermined paper shape.

14. The alignment device of claim 12 further comprising a third generally planar surface having a second groove, the second groove generally shaped to receive the paper to be cut, the third generally planar surface being slightly offset from the second planar surface; and wherein the second groove is located in a position on the third generally planar surface so that the paper may be cut with a cutting means to achieve a predetermined paper shape.

15. The alignment device of claim 13 wherein each generally planar surface comprises a ridge, the ridge having a height, and wherein the ridge comprises a groove.

16. The alignment device of claim 14 wherein the generally planar surfaces are arranged in steps, such that the generally planar surfaces substantially sequentially guide the positioning of a piece of paper for each cut.

17. The alignment device of claim 12 wherein the alignment device comprises a first planar surface, a second planar surface disposed on the first planar surface, a third planar surface disposed on the second planar surface, a fourth planar surface disposed on the third planar surface, a fifth planar surface disposed on the fourth planar surface, and a sixth planar surface disposed on the fifth planar surface.
